(19) United States
(12) Patent Application Publication
(10) Pub. No.: US 2026/0038149 A1
(43) Pub. Date: Feb. 5, 2026

(54) Split-Cadence Eye Tracking

(71) Applicant: Apple Inc., Cupertino, CA (US)

(72) Inventors: Lionel E. Edwin, San Jose, CA (US); Tom Sengelaub, Oakland, CA (US)

(73) Assignee: Apple Inc., Cupertino, CA (US)

(21) Appl. No.: 19/272,928

(22) Filed: Jul. 17, 2025

Related U.S. Application Data
(60) Provisional application No. 63/677,339, filed on Jul. 30, 2024.

(51) Int. Cl. G06T 7/73; G06F 3/01; H04N 23/80

(52) U.S. Cl. CPC G06T 7/74; G06F 3/013; H04N 23/80

(57) ABSTRACT

A split-cadence eye tracking that includes a lower-cadence pipeline that estimates the multiple (e.g., five) degrees of freedom (DoF) position of the eye with respect to the camera/device to estimate gaze, and a higher-cadence, faster pipeline that estimates only the two DoF of rotation of the eye and interpolates from a previous reference frame to estimate gaze. Diffuse lighting may be used to capture images of the pupil for low-cadence frames, and specular lighting may be used to capture images of glints for high-cadence frames.

### PRIORITY CLAIM

This application claims benefit of priority to U.S. Provisional Application Ser. No. 63/677,339, titled “Split-Cadence Eye Tracking,” filed Jul. 30, 2024, and which is hereby incorporated herein by reference in its entirety.

### BACKGROUND

Extended reality (XR) systems such as mixed reality (MR) or augmented reality (AR) systems combine computer generated information (referred to as virtual content) with real world images or a real-world view to augment, or add content to, a user's view of the world. XR systems may thus be utilized to provide an interactive user experience for multiple applications, such as applications that add virtual content to a real-time view of the viewer's environment, interacting with virtual training environments, gaming, remotely controlling drones or other mechanical systems, viewing digital media content, interacting with the Internet, or the like.

Eye tracking is the process of monitoring an eye to determine the direction of the eye's vision, also called gaze. For example, the location of the pupil can provide an approximate gaze tracking metric. As an example, Purkinje images, also called glints, can provide a means for a gaze tracking system to track movement of the pupil.

### SUMMARY

Various embodiments of methods and apparatus for split-cadence eye tracking in a device, for example head-mounted devices (HMDs) including but not limited to HMDs used in extended reality (XR) applications and systems, are described. HMDs may include wearable devices such as headsets, helmets, goggles, or glasses. An XR system may include an HMD which may include one or more cameras that may be used to capture still images or video frames of the user's environment. The HMD may include lenses positioned in front of the eyes through which the wearer can view the environment. In XR systems, virtual content may be displayed on or projected onto these lenses to make the virtual content visible to the wearer while still being able to view the real environment through the lenses. Alternatively, the HMD may include opaque display screens positioned in front of the user's eyes via which images or video of the environment captured by the one or more cameras can be displayed for viewing by a user, possibly augmented by virtual content in an XR system, and typically through optics or eyepieces positioned between the displays and the user's eyes.

In a device that implements an eye tracking system, an eye tracking algorithm implemented by the system may track the position of the pupil or other eye features based on images of the eyes captured by eye-facing camera(s) to determine gaze direction. In an example eye tracking system, one or more infrared (IR) light sources emit IR light towards a user's eye. A portion of the IR light is reflected off the eye and captured by an eye tracking camera. Images captured by the eye tracking camera may be input to a feature detection process, for example a glint and pupil detection process, which may be implemented by one or more processors of a controller of the HMD. Results of the process are passed to a gaze estimation process, for example implemented by one or more processors of the controller, to estimate the user's current point of gaze (or gaze vector) based in part on a three-dimensional model of the eye, as well as on current position of the eye with respect to the device. The model of the user's eye may be generated based on images of the eye captured by the eye-facing camera(s). The model may include, but is not limited to, information on the center of the eye, center of the pupil, eye center to pupil distance, inter-pupillary distance (IPD), and other information about the pupil, iris, and cornea surface. Note that the gaze tracking may be performed for one or for both eyes.

A conventional eye tracking algorithm solves an eye estimation problem in five degrees of freedom (5 DoF). A current position of the eye with respect to the eye tracking camera (or more generally, with the device) in three dimensions (X, Y, Z), and rotation of the eye in 2 DoF (elevation and azimuth (E and A), or pitch and yaw). Accurate and precise gaze tracking typically requires estimation of the gaze vector at a relatively high frame rate (low latency), as the user's eye may move rapidly. Conventionally, the 5 DoF estimation would be done for every frame.

For an eye tracking system in some devices, such as a glasses-type HMD, the form factor of the device may impose limitations on the placement of the camera(s) and illumination elements, as well as on other components such as processors and power sources. Traditional gaze tracking techniques may be limited due to the structural restrictions of such devices. A gaze tracking system in such a device may require gaze tracking components and techniques that meet the architectural and functional restraints of such devices, including power and compute restraints.

Embodiments of a split-cadence eye tracking method and apparatus are described that leverage the fact (or assumption) that, while the user's eyes may move often and rapidly at any time, the position of the eye with respect to the device remains relatively fixed for much longer periods. For example, a glasses-type HMD may remain in a fixed position with respect to the eyes after an initial calibration and may only change occasionally if the user adjusts the HMD or the HMD itself shifts a bit. Thus, the eye estimation problem can be split into two pipelines:
a lower-cadence full pipeline that estimates the five DoF position eye with respect to the camera/device (referred to as a low-cadence pipeline); and
a higher-cadence, faster pipeline (referred to as a high-cadence pipeline) that estimates only the two DoF rotation of the eye (assuming the remaining three DoF are unchanged from a previous reference or “anchor” frame).

In embodiments, an initial five DoF estimation may be performed by the low-cadence pipeline to establish a reference frame. Subsequently, the high-cadence pipeline is used to track elevation and azimuth (two DoF) of the eye(s) until a trigger event occurs for the low-cadence pipeline indicating that a new reference frame needs to be estimated. A new reference frame (five DoF) is then established by the low-cadence pipeline, after which the high-cadence pipeline is used to track elevation and azimuth. This may continue as long as the device is in use. A trigger event may be a timed event (e.g., every 200 milliseconds) or a detected event (e.g., movement of the device with respect to the eye(s) by one or more sensors of the device).

In some embodiments, the split-cadence architecture may be leveraged to reduce the need for illumination. Images to estimate the two DoF by the high-cadence pipeline may only require glint information to be located and processed. Thus, these images may be captured with reduced, specular light output to perform specular imaging. More eye features (pupil/iris features, for example) may need to be detected from images in the low-cadence pipeline, in addition to glints. Thus, these images may be captured using diffuse light output. Reducing the light required for specular imaging in the low-cadence pipeline may reduce power consumption by the light sources.

Embodiments of the split-cadence eye tracking method may thus enable a desired reporting rate (gaze estimation) with low latency while maintaining eye estimation (gaze/pupil/vergence) performance and satisfying the architectural and functional restraints of devices such as a glasses-type HMD, including power and compute restraints.

### BRIEF DESCRIPTION OF THE DRAWINGS

FIG. 1 graphically illustrates splitting the eye estimation problem into a two DoF problem and a 5 DoF problem in a device that includes an eye tracking system, according to some embodiments.

FIG. 2 illustrates processing reference frames and fast frames in a device that includes an eye tracking system, according to some embodiments.

FIGS. 3A and 3B illustrate capturing images of the pupil using diffuse lighting and images of glints using specular lighting in a device that includes an eye tracking system, according to some embodiments.

FIG. 4 illustrates a low-cadence full pipeline that estimates the five DoF position eye with respect to the camera/device and a high-cadence pipeline that estimates only the two DoF rotation of the eye, according to some embodiments.

FIG. 5 is a high-level flowchart of a method that splits the eye estimation problem into a two DoF problem and a 5 DoF problem in a device that includes an eye tracking system, according to some embodiments.

FIG. 6 is a flowchart of a method that splits the eye estimation problem into a two DoF problem and a 5 DoF problem in which images of the pupil are captured using diffuse lighting and images of glints are captured using specular lighting in a device that includes an eye tracking system, according to some embodiments.

FIGS. 7A through 7C illustrate example devices in which the methods of FIGS. 1 through 5B may be implemented, according to some embodiments.

FIG. 8 is a block diagram illustrating an example device that may include components and implement methods as illustrated in FIGS. 1 through 6, according to some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, paragraph (f), for that unit/circuit/component. Additionally, “configured to” can include generic structure (e.g., generic circuitry) that is manipulated by software or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On” or “Dependent On.” As used herein, these terms are used to describe one or more factors that affect a determination. These terms do not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

“Or.” When used in the claims, the term “or” is used as an inclusive or and not as an exclusive or. For example, the phrase “at least one of x, y, or z” means any one of x, y, and z, as well as any combination thereof.

### DETAILED DESCRIPTION

Various embodiments of methods and apparatus for split-cadence eye tracking in a device, for example head-mounted devices (HMDs) including but not limited to HMDs used in extended reality (XR) applications and systems, are described. HMDs may include wearable devices such as headsets, helmets, goggles, or glasses. An XR system may include an HMD which may include one or more cameras that may be used to capture still images or video frames of the user's environment. The HMD may include lenses positioned in front of the eyes through which the wearer can view the environment. In XR systems, virtual content may be displayed on or projected onto these lenses to make the virtual content visible to the wearer while still being able to view the real environment through the lenses. Alternatively, the HMD may include opaque display screens positioned in front of the user's eyes via which images or video of the environment captured by the one or more cameras can be displayed for viewing by a user, possibly augmented by virtual content in an XR system, and typically through optics or eyepieces positioned between the displays and the user's eyes. While embodiments of the split-cadence eye tracking methods are generally described herein with respect to HMDs, such as HMDs used in XR systems, embodiments may be applied in any application or system that employs eye or gaze tracking, for example health monitoring systems or techniques.

In a device that implements an eye tracking system, an eye tracking algorithm implemented by the system may track the position of the pupil or other eye features based on images of the eyes captured by eye-facing camera(s) to determine gaze direction. In an example eye tracking system, one or more infrared (IR) light sources emit IR light towards a user's eye. A portion of the IR light is reflected off the eye and captured by an eye tracking camera. Images captured by the eye tracking camera may be input to a feature detection process, for example a glint and pupil detection process, which may be implemented by one or more processors of a controller of the HMD. Results of the process are passed to a gaze estimation process, for example implemented by one or more processors of the controller, to estimate the user's current point of gaze (or gaze vector) based in part on a three-dimensional model of the eye, as well as on current position of the eye with respect to the device. The model of the user's eye may be generated based on images of the eye captured by the eye-facing camera(s). The model may include, but is not limited to, information on the center of the eye, center of the pupil, eye center to pupil distance, inter-pupillary distance (IPD), and other information about the pupil, iris, and cornea surface. Note that the gaze tracking may be performed for one or for both eyes.

Accurate eye tracking may be required for several reasons including but not limited to dynamic display distortion and color correction, and is especially important as displays get smaller. A device that implements eye tracking may include a display positioned in front of the user's eyes, and eyepieces located between the user's eyes and the display. Dynamic display distortion may be applied to images to be displayed to account for distortion caused by the lenses with respect to the user's current gaze direction as detected by the eye tracking system. Color correction or other image corrections may also be applied to frames based on the current gaze direction as detected by the eye tracking system.

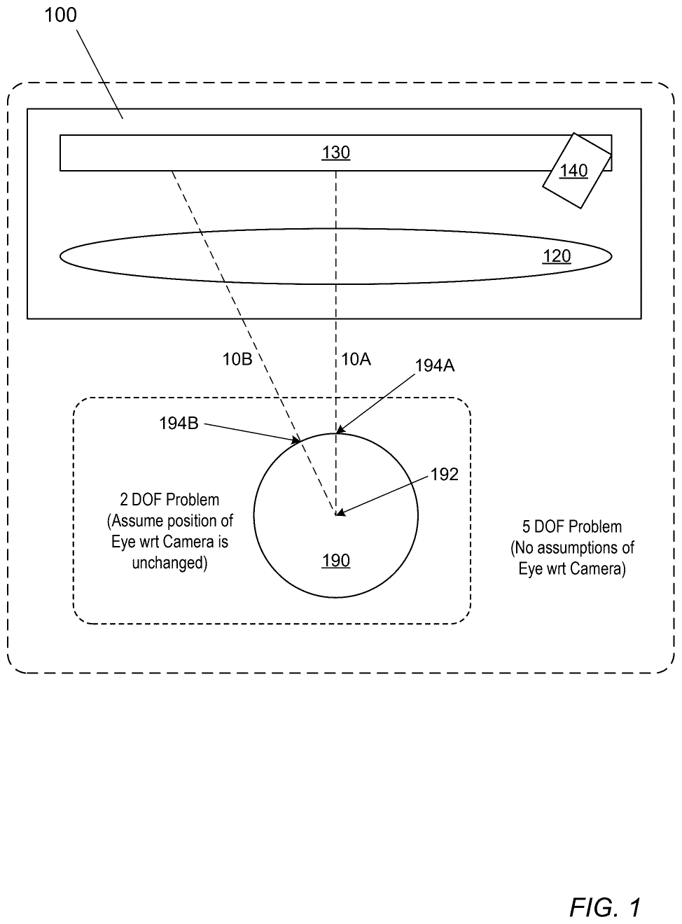

FIG. 1 graphically illustrates splitting the eye estimation problem into a two DoF problem and a 5 DoF problem in a device that includes an eye tracking system, according to some embodiments. In some embodiments, a device 100 (e.g., a HMD) may include a display 130 and optics (or “eyepieces”) 120 positioned in front of a user's eye 190. An eye-facing camera 140 may be positioned to capture video or images of the eye 190, in particular of the iris, pupil, and cornea surface, either directly or through the optics 120.

In some embodiments, during device calibration or registration, a model of the user's eye(s) may be generated based on images of the eye captured by the eye-facing camera 140. The model may include, but is not limited to, information on the center 192 of the eye, center of the pupil, eye center to pupil distance, inter-pupillary distance (IPD), and other information about the pupil, iris, and cornea surface. In use, an eye tracking system may estimate the position of the pupil based on images of the eyes captured by eye-facing camera 140 to determine, based in part on the eye model, the current gaze direction. FIG. 1 shows the eye with the pupil at a first position 194A and a second position 194B, with respective gaze vectors 10A and 10B determined from at least the known center 192 of the eye and the currently detected pupil position 194.

A conventional eye tracking algorithm solves an eye estimation problem in five degrees of freedom (5 DoF). A current position of the eye with respect to the eye tracking camera (or more generally, with the device) in three dimensions (X, Y, Z), and rotation of the eye in 2 DoF (elevation and azimuth (E and A), or pitch and yaw). Accurate and precise gaze tracking typically requires estimation of the gaze vector at a relatively high frame rate (low latency), as the user's eye may move rapidly. Conventionally, the 5 DoF estimation would be done for every frame.

For an eye tracking system in some devices, such as a glasses-type HMD, the form factor of the device may impose limitations on the placement of the camera(s) 140 and illumination elements, as well as on other components such as processors and power sources. Traditional gaze tracking techniques may be limited due to the structural restrictions of such devices. A gaze tracking system in such a device may require gaze tracking components and techniques that meet the architectural and functional restraints of such devices, including power and computation restraints.

Embodiments of a split-cadence eye tracking method and apparatus are described that leverage the fact (or assumption) that, while the user's eyes may move often and rapidly at any time, the position of the eye with respect to the device remains relatively fixed for much longer periods. For example, a glasses-type HMD may remain in a fixed position with respect to the eyes after an initial calibration and may only change occasionally if the user adjusts the HMD or the HMD itself shifts a bit. In addition, assuming a fixed eye center, there is a 1 to 1 mapping between 2D (elevation and eye rotation) angles and 2D eye feature movement in image space (movement of an eye feature such as a glint or pupil feature is correlated with eye rotation). Thus, the eye estimation problem can be split into two pipelines:
a lower-cadence full pipeline that estimates the five DoF position eye with respect to the camera/device (referred to as a low-cadence pipeline); and
a higher-cadence, faster pipeline (referred to as a high-cadence pipeline) that estimates only the two DoF rotation of the eye (assuming the remaining three DoF are unchanged from a previous reference frame).

The lower-cadence pipeline estimates both position of the eye with respect to the device and orientation (rotation) of the eye to establish a reference frame. The higher-cadence pipeline does not estimate position, assuming the position has not changed; it estimates the delta orientation of the eye (azimuth and elevation) from a frame of reference (the reference frame). Note that while embodiments are generally described in reference to one eye, the methods described herein may be applied to both eyes in some embodiments.

In embodiments, the low-cadence pipeline generates reference frames, which take longer to compute, while the high-cadence pipeline generates fast frames, which are much faster to compute. Interpolation may be performed between reference frames using the fast frames. This allows for lower eye motion to gaze output latency.

In embodiments, an initial five DoF estimation may be performed by the low-cadence pipeline to establish a reference (or anchor) frame. Subsequently, the high-cadence pipeline may be used to track elevation and azimuth (two DoF) of the eye(s) until a trigger event occurs for the low-cadence pipeline indicating that a new reference frame needs to be estimated. A new reference frame (five DoF) may then established by the low-cadence pipeline, after which the high-cadence pipeline is used to track elevation and azimuth. This may continue as long as the device is in use. A trigger event may be a timed event (e.g., every 200 milliseconds) or a detected event (e.g., movement of the device with respect to the eye(s) by one or more sensors of the device).

While embodiments are generally described as estimating five DoF for a reference frame in the low-cadence pipeline and two DoF for a fast frame in a high-cadence pipeline, various embodiments may estimate more or fewer DoF in one or both of the pipelines. In some embodiments, the high-cadence pipeline may estimate at a minimum two DoF, but may have a trigger event or an augmented method to estimate one or more additional DoF. Note that in some devices or applications, a low-cadence pipeline may not be necessary, and only a high-cadence pipeline may be implemented, with position of the eye remaining fixed (for example, in an application where the device is firmly fixed with respect to the eye).

In some embodiments, the split-cadence architecture may be leveraged to reduce the need for illumination. Images to estimate the two DoF by the high-cadence pipeline may only require glint information to be located and processed. (A glint is a reflection of a light source off the cornea of the eye). Thus, these images may be captured with reduced light output to perform specular imaging. More eye features (pupil/iris features, for example) may need to be detected from images in the low-cadence pipeline, in addition to glints. Thus, these images may be captured using diffuse light output. Reducing the light required for specular imaging in the low-cadence pipeline may reduce power consumption by the light sources. Thus, embodiments may achieve power/compute optimization by running only the specular imaging at a fast cadence and diffuse imaging at a slower cadence. For example, 2 ms exposure @5 Hz diffuse imaging, and 0.2 ms exposure @30 Hz specular imaging.

In some embodiments, since the glints are typically located in only a portion of a frame/image, the method may only read out a subset of the rows (or alternatively columns) of pixels in an image, the subset known to contain the glint region of the image of the eye. Reading out only a subset of the rows or columns to be processed may reduce latency, reduce computation requirements, and reduce power consumption.

In some embodiments, an image of glints captured with specular lighting may essentially be a dark image with a few brighter glints. Centroids of the glints may be extracted using hardware. Thus, CPU usage can be reduced by extracting the centroids of the glints in hardware to increase computation efficiency and reduce power consumption.

Embodiments of the split-cadence eye tracking method may thus enable a desired reporting rate (gaze estimation) with low latency while maintaining eye estimation (gaze/pupil/vergence) performance and satisfying the architectural and functional restraints of devices such as a glasses-type HMD, including power and compute restraints.

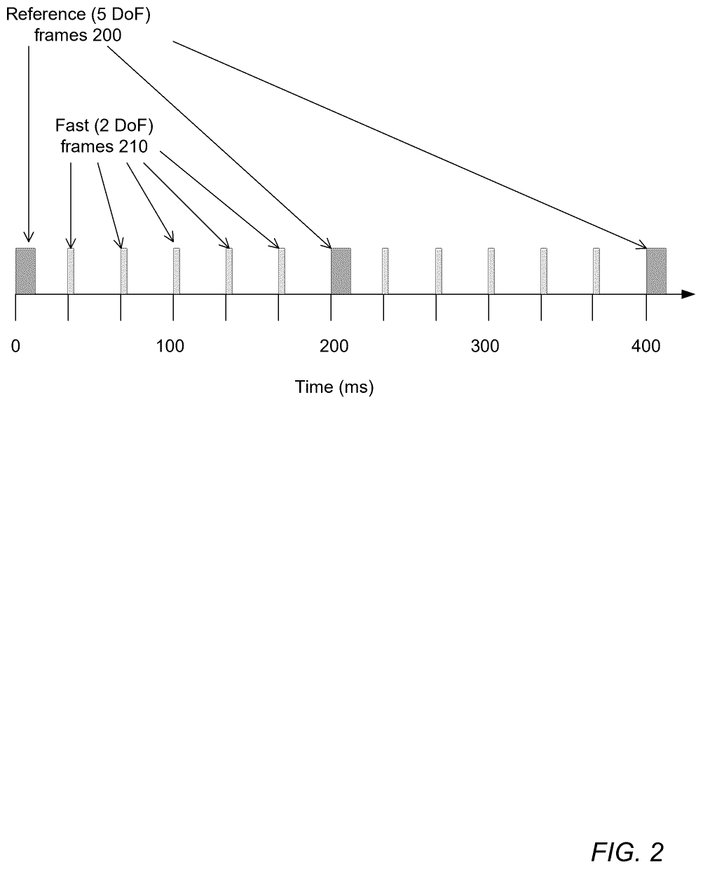

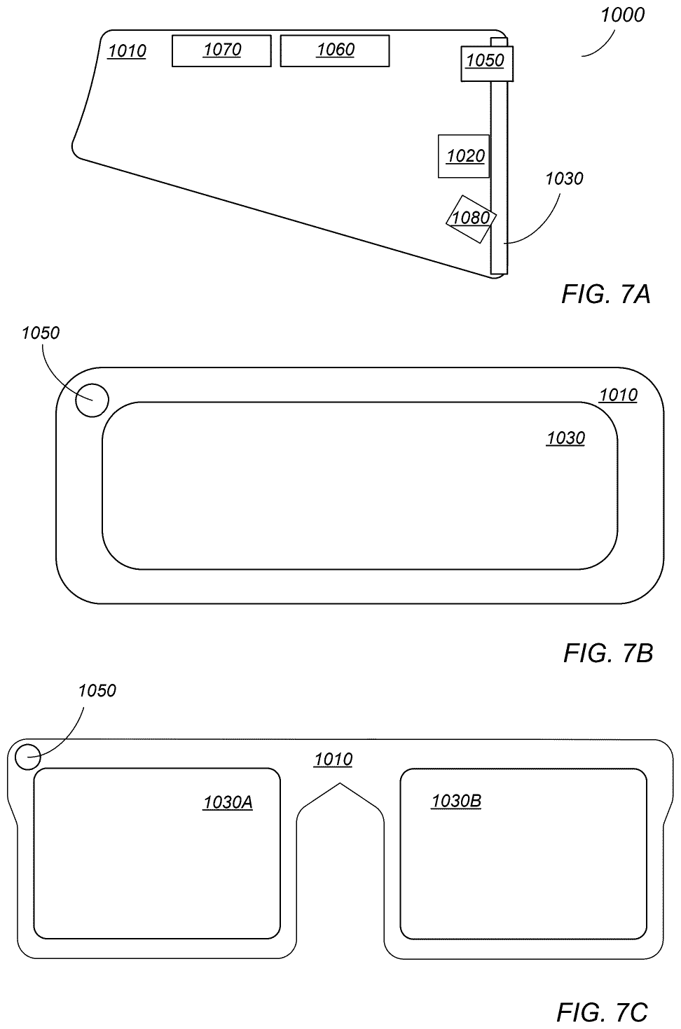

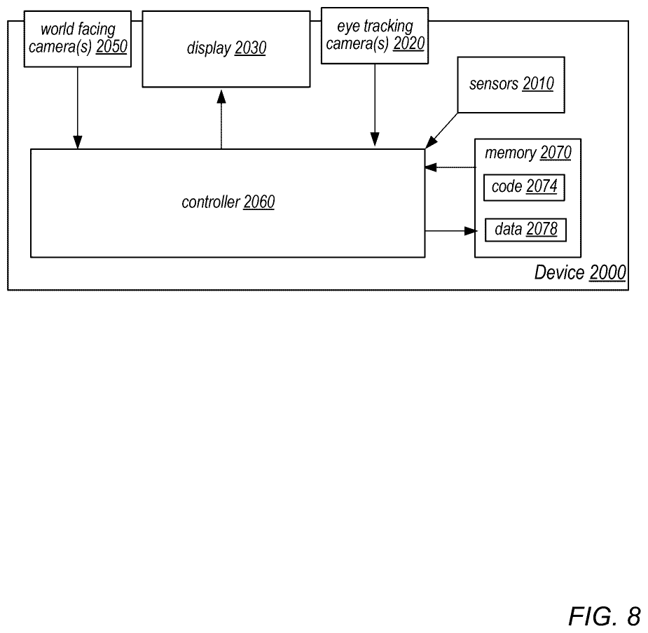

The methods as illustrated in FIGS. 2 through 6 may be implemented by processes executing on or by one or more processors of a controller which is communicatively coupled to other components such as cameras, lights, and sensors in a device such as an HMD. Example devices in which the methods and apparatus may be implemented are illustrated in FIGS. 7A-7C and FIG. 8.

FIG. 2 illustrates processing reference frames and fast frames in a device that includes an eye tracking system, according to some embodiments. A conventional eye tracking algorithm solves an eye estimation problem in five degrees of freedom (5 DoF). A current position of the eye with respect to the eye tracking camera (or more generally, with the device) in three dimensions (X, Y, Z), and rotation of the eye in 2 DoF (elevation and azimuth (E and A), or pitch and yaw). Accurate and precise gaze tracking typically requires estimation of the gaze vector at a relatively high frame rate (low latency), as the user's eye may move rapidly. Conventionally, the 5 DoF estimation would be done for every frame.

Embodiments of a split-cadence eye tracking method and apparatus may leverage the fact (or assumption) that, while the user's eyes may move often and rapidly at any time, the position of the eye with respect to the device remains relatively fixed for much longer periods. For example, a glasses-type HMD may remain in a fixed position with respect to the eyes after an initial calibration and may only change occasionally if the user adjusts the HMD or the HMD itself shifts a bit. Thus, the eye estimation problem can be split into two pipelines:
a lower-cadence full pipeline that estimates the five DoF position eye with respect to the camera/device (referred to as a low-cadence pipeline); and
a higher-cadence, faster pipeline (referred to as a high-cadence pipeline) that estimates only the two DoF rotation of the eye (assuming the remaining three DoF are unchanged from a previous reference frame).

FIG. 2 shows an eye tracking timeline in milliseconds, starting from an initial point (e.g., when the device is turned on by the user and registered or calibrated). In embodiments, an initial five DoF estimation may be performed by the low-cadence pipeline to establish a reference frame 200. Subsequently, the high-cadence pipeline is used to track elevation and azimuth (two DoF) of the eye(s) (fast frames 210) until a trigger event occurs for the low-cadence pipeline indicating that a new reference frame 200 needs to be estimated. A new reference frame (five DoF) 200 is then established by the low-cadence pipeline, after which the high-cadence pipeline is used to track elevation and azimuth (fast frames 210). This may continue as long as the device is in use. A trigger event may be a timed event (e.g., every 200 milliseconds) or a detected event (e.g., detected movement of the device with respect to the eye(s) by one or more sensors of the device).

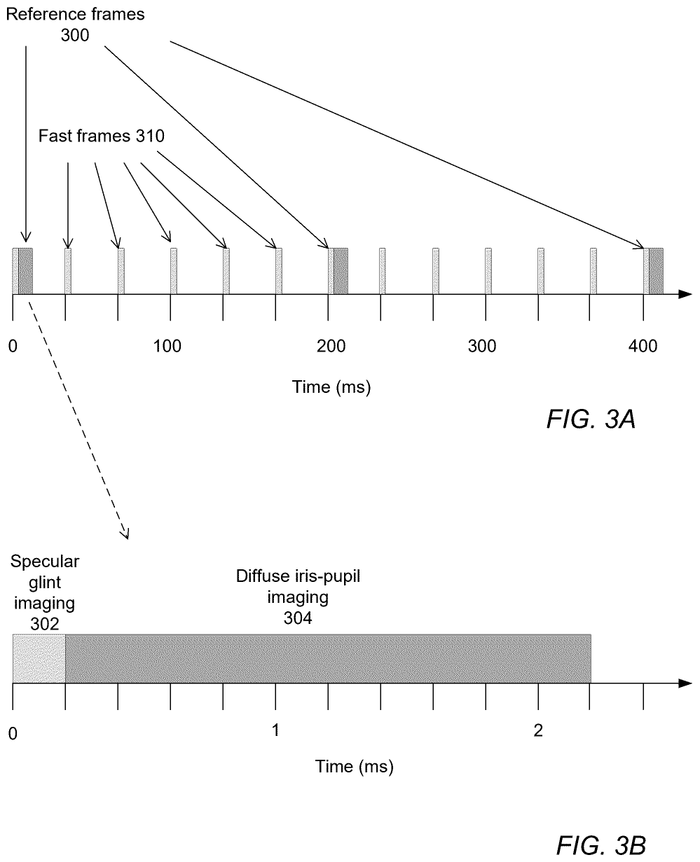

FIGS. 3A and 3B illustrate capturing images of the pupil using diffuse lighting and images of glints using specular lighting in a device that includes an eye tracking system, according to some embodiments. In some embodiments, the split-cadence architecture may be leveraged to reduce the need for illumination. Images to estimate the two DoF by the high-cadence pipeline (fast frames 310) may only require glint information to be located and processed. Thus, these images may be captured with reduced, specular light output to perform specular imaging. More eye features (pupil/iris features, for example) may need to be detected from images in the low-cadence pipeline, (reference frames 300) in addition to glints. Thus, these images may be captured using diffuse light output, or a combination of specular and diffuse light. Reducing the light required for specular imaging in the low-cadence pipeline may reduce power consumption by the light sources.

FIG. 3A shows an eye tracking timeline in milliseconds, starting from an initial point (e.g., when the device is put on by the user and registered or calibrated), according to some embodiments. An initial five DoF estimation may be performed by the low-cadence pipeline to establish a reference frame 300. An image or images used to establish a reference frame 300 may be captured using diffuse lighting, or a combination of diffuse and specular lighting. Subsequently, the high-cadence pipeline is used to track elevation and azimuth (two DoF) of the eye(s) (fast frames 310) until a trigger event occurs for the low-cadence pipeline indicating that a new reference frame 300 needs to be estimated. An image used to establish a fast frame 310 may be captured using only specular lighting. A new reference frame (five DoF) 300 is then established by the low-cadence pipeline, after which the high-cadence pipeline is used to track elevation and azimuth (fast frames 310). This may continue as long as the device is in use. A trigger event may be a timed event (e.g., every 200 milliseconds) or a detected event (e.g., detected movement of the device with respect to the eye(s) by one or more sensors of the device).

FIG. 3B illustrates capturing image(s) for a reference frame, according to some embodiments. A five DoF estimation may be performed by the low-cadence pipeline to establish a reference frame 300. An image or images used to establish a reference frame 300 may be captured using specular lighting to perform specular glint imaging for estimating two DoF (elevation and azimuth), and diffuse lighting to perform iris-pupil imaging for estimating the other three DoF (X, Y, Z).

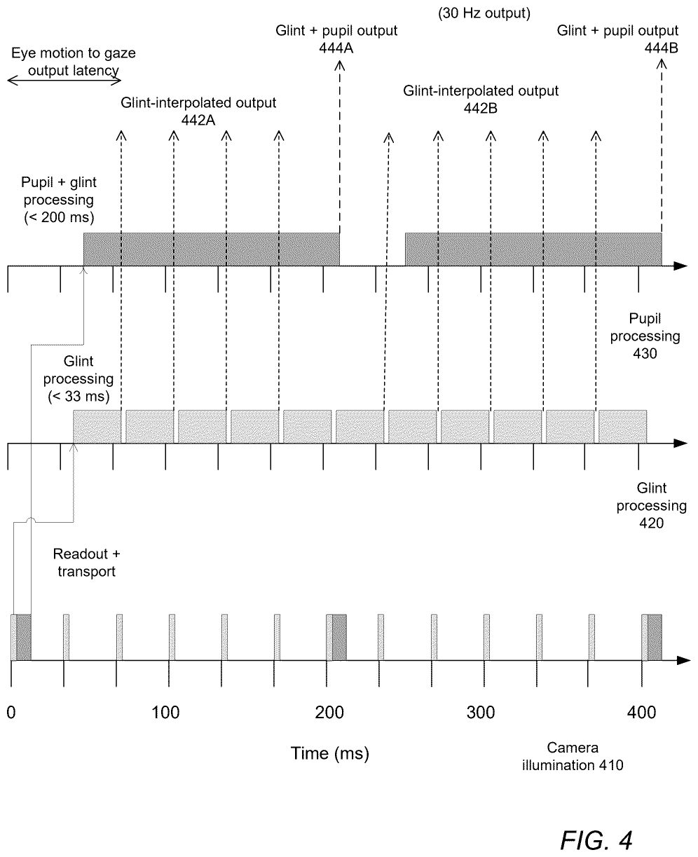

FIG. 4 illustrates a low-cadence full pipeline that estimates the five DoF position eye with respect to the camera/device and a high-cadence pipeline that estimates only the two DoF rotation of the eye, according to some embodiments.

Camera illumination 410 corresponds to the camera illumination method as illustrated in FIG. 3. An initial five DoF estimation may be performed by the low-cadence pipeline to establish a reference frame. An image or images used to establish a reference frame may be captured using diffuse lighting, or a combination of diffuse and specular lighting. Subsequently, the high-cadence pipeline is used to track elevation and azimuth (two DoF) of the eye(s) until a trigger event occurs for the low-cadence pipeline indicating that a new reference frame needs to be estimated.

Glint processing 420 corresponds to the high-cadence pipeline. Images for fast frames may be captured using only specular lighting. The high-cadence pipeline processes the images (which may, for example, take approximately 33 milliseconds or less per fast frame), and the results may be used to generate glint-interpolated output 442 based on a last reference frame. In some embodiments, since the glints are located in only a portion of a frame, the method may only read out a subset of the rows (or alternatively columns) of pixels in an image, the subset known to contain the glint region of the image of the eye. Reading out only a subset of the rows or columns may reduce latency and computation requirements, and may conserve power in the device.

While the high-cadence pipeline is described as processing images captured using only specular lighting to generate glint-interpolated output 442, other implementations of a high-cadence pipeline may be used that do not perform the full processing of the low-cadence pipeline. For example, in an alternative implementation, the high-cadence pipeline may process fully exposed images rather than images captured using only specular lighting. A hardware block may be used that compares two frames to determine how one or more eye features have moved between the frames. The features could be glints or any other eye features captured in the images. The hardware block generates sparse motion vector that can be used to interpolate between reference frames similar to the glint-interpolated output 442.

Pupil processing 430 corresponds to the low-cadence pipeline. Images for reference frames may be captured using diffuse lighting, or a combination of diffuse and specular lighting. The low-cadence pipeline processes the images (which may, for example, take approximately 200 milliseconds or less per reference frame), and the results may be used to generate glint+pupil output 444.

A new reference frame (five DoF) may thus be established by the low-cadence pipeline approximately every 200 milliseconds, or alternatively in response to some other trigger event, while the high-cadence pipeline is used to track elevation and azimuth (fast frames) and apply interpolation based on the last reference frame and the fast frames to estimate gaze between the reference frames. The low- and high-cadence pipelines may continue processing images and generating estimated gaze output as long as the device is in use. A trigger event may be a timed event (e.g., every 200 milliseconds) or a detected event (e.g., detected movement of the device with respect to the eye(s) by one or more sensors of the device).

Note that the number of frames and the frequency of the low-cadence and high-cadence pipelines are given by way of example, and are not intended to be limiting.

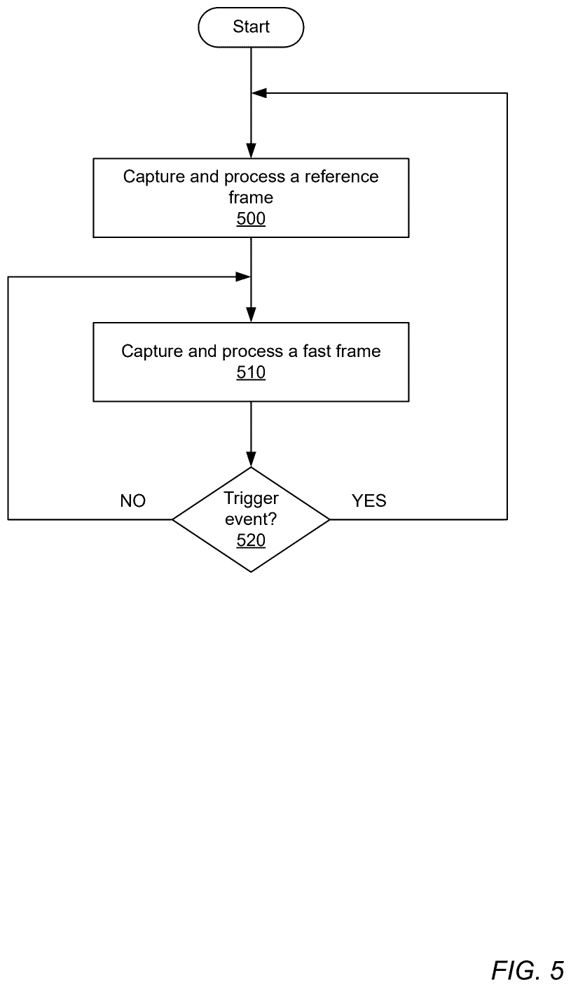

FIG. 5 is a high-level flowchart of a method that splits the eye estimation problem into a two DoF problem and a 5 DoF problem in a device that includes an eye tracking system, according to some embodiments. As indicated at 500, a reference frame (also referred to as a reference frame) is captured and processed by the low-cadence pipeline. In embodiments, an initial five DoF estimation may be performed by the low-cadence pipeline to establish a reference (or anchor) frame. As indicated at 510 and 520, fast frames are captured and processed by the high-cadence pipeline until a trigger event occurs. The high-cadence pipeline is used to track elevation and azimuth (two DoF) of the eye(s) (fast frames) until a trigger event 520 occurs indicating that a new reference frame needs to be estimated by the low-cadence pipeline A trigger event may be a timed event (e.g., every 200 milliseconds) or a detected event (e.g., detected movement of the device with respect to the eye(s) by one or more sensors of the device).

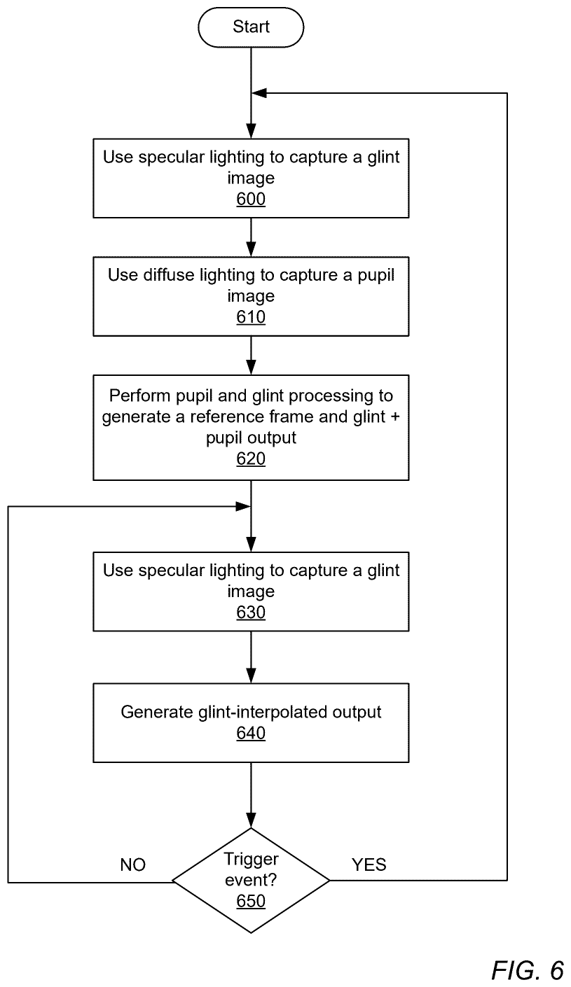

FIG. 6 is a flowchart of a method that splits the eye estimation problem into a two DoF problem and a 5 DoF problem in which images of the pupil are captured using diffuse lighting and images of glints are captured using specular lighting in a device that includes an eye tracking system, according to some embodiments. Elements 600 through 620 correspond to a low-cadence pipeline. As indicated at 600, specular lighting may be used to capture a glint image. At 610, diffuse lighting may be used to capture a pupil/iris image. As indicated at 620, pupil and glint processing may generate a reference frame and glint+pupil gaze tracking output.

Elements 630 and 640 correspond to a high-cadence pipeline. As indicated at 630, specular lighting may be used to capture a glint image. At 640, the low-cadence pipeline may apply interpolation based on the last reference frame and the fast frame (the glint image) to estimate gaze (glint-interpolated output) between the reference frames. The high-cadence pipeline is used to track elevation and azimuth (two DoF) of the eye(s) (fast frames) until a trigger event 650 occurs indicating that a new reference frame needs to be estimated by the low-cadence pipeline. A trigger event may be a timed event (e.g., every 200 milliseconds) or a detected event (e.g., detected movement of the device with respect to the eye(s) by one or more sensors of the device).

The methods as illustrated in FIGS. 1 through 6 may be implemented by processes executing on or by one or more processors of a controller which is communicatively coupled to other components such as cameras and sensors in a device such as an HMD. Example devices in which the methods and apparatus may be implemented are illustrated in FIGS. 7A-7C and FIG. 8.

FIGS. 7A through 7C illustrate example devices in which the methods of FIGS. 1 through 6 may be implemented, according to some embodiments. Note that the HMDs 1000 as illustrated in FIGS. 7A through 7C are given by way of example, and are not intended to be limiting. In various embodiments, the shape, size, and other features of an HMD 1000 may differ, and the locations, numbers, types, and other features of the components of an HMD 1000 and of the eye imaging system. FIG. 7A shows a side view of an example HMD 1000, and FIGS. 7B and 7C show alternative front views of example HMDs 1000, with FIG. 7A showing device that has one lens 1030 that covers both eyes and FIG. 7B showing a device that has right 1030A and left 1030B lenses.

HMD 1000 may include lens(es) 1030, mounted in a wearable housing or frame 1010. HMD 1000 may be worn on a user's head (the “wearer”) so that the lens(es) is disposed in front of the wearer's eyes. In some embodiments, an HMD 1000 may implement any of various types of display technologies or display systems. For example, HMD 1000 may include a display system that directs light that forms images (virtual content) through one or more layers of waveguides in the lens(es) 1030; output couplers of the waveguides (e.g., relief gratings or volume holography) may output the light towards the wearer to form images at or near the wearer's eyes. As another example, HMD 1000 may include a direct retinal projector system that directs light towards reflective components of the lens(es); the reflective lens(es) is configured to redirect the light to form images at the wearer's eyes.

In some embodiments, HMD 1000 may also include one or more sensors that collect information about the wearer's environment (video, depth information, lighting information, etc.) and about the wearer (e.g., eye or gaze tracking sensors, head motion sensors, etc.). The sensors may include one or more of, but are not limited to one or more eye tracking cameras 1020 (e.g., infrared (IR) cameras) that capture views of the user's eyes, one or more world-facing or PoV cameras 1050 (e.g., RGB video cameras) that can capture images or video of the real-world environment in a field of view in front of the user, and one or more ambient light sensors that capture lighting information for the environment. Cameras 1020 and 1050 may be integrated in or attached to the frame 1010. HMD 1000 may also include one or more light sources 1080 such as LED or infrared point light sources that emit light (e.g., light in the IR portion of the spectrum) towards the user's eye or eyes.

A controller 1060 for the XR system may be implemented in the HMD 1000, or alternatively may be implemented at least in part by an external device (e.g., a computing system or handheld device) that is communicatively coupled to HMD 1000 via a wired or wireless interface. Controller 1060 may include one or more of various types of processors, image signal processors (ISPs), graphics processing units (GPUs), coder/decoders (codecs), system on a chip (SOC), CPUs, and/or other components for processing and rendering video and/or images. In some embodiments, controller 1060 may render and composite frames (each frame including a left and right image) that include virtual content based at least in part on inputs obtained from the sensors and from an eye tracking system, and may provide the frames to the display system.

Memory 1070 for the XR system may be implemented in the HMD 1000, or alternatively may be implemented at least in part by an external device (e.g., a computing system) that is communicatively coupled to HMD 1000 via a wired or wireless interface. The memory 1070 may, for example, be used to record video or images captured by the one or more cameras 1050 integrated in or attached to frame 1010. Memory 1070 may include any type of memory, such as dynamic random-access memory (DRAM), synchronous DRAM (SDRAM), double data rate (DDR, DDR2, DDR3, etc.) SDRAM (including mobile versions of the SDRAMs such as mDDR3, etc., or low power versions of the SDRAMs such as LPDDR2, etc.), RAMBUS DRAM (RDRAM), static RAM (SRAM), etc. In some embodiments, one or more memory devices may be coupled onto a circuit board to form memory modules such as single inline memory modules (SIMMs), dual inline memory modules (DIMMs), etc. Alternatively, the devices may be mounted with an integrated circuit implementing system in a chip-on-chip configuration, a package-on-package configuration, or a multi-chip module configuration. In some embodiments DRAM may be used as temporary storage of images or video for processing, but other storage options may be used in an HMD to store processed data, such as Flash or other “hard drive” technologies. This other storage may be separate from the externally coupled storage mentioned below.

While FIGS. 7A through 7C only show light sources 1080 and cameras 1020 and 1050 for one eye, embodiments may include light sources 1080 and cameras 1020 and 1050 for each eye, and gaze tracking may be performed for both eyes. In addition, the light sources, 1080, eye tracking camera 1020 and PoV camera 1050 may be located elsewhere than shown.

Embodiments of an HMD 1000 as illustrated in FIGS. 7A-7C may, for example, be used in augmented or mixed (AR) applications to provide augmented or mixed reality views to the wearer. HMD 1000 may include one or more sensors, for example located on external surfaces of the HMD 1000, that collect information about the wearer's external environment (video, depth information, lighting information, etc.); the sensors may provide the collected information to controller 1060 of the XR system. The sensors may include one or more visible light cameras 1050 (e.g., RGB video cameras) that capture video of the wearer's environment that, in some embodiments, may be used to provide the wearer with a virtual view of their real environment. In some embodiments, video streams of the real environment captured by the visible light cameras 1050 may be processed by the controller 1060 of the HMD 1000 to render augmented or mixed reality frames that include virtual content overlaid on the view of the real environment, and the rendered frames may be provided to the display system. In some embodiments, input from the eye tracking camera 1020 may be used in a PCCR gaze tracking process executed by the controller 1060 to track the gaze/pose of the user's eyes for use in rendering the augmented or mixed reality content for display. In addition, one or more of the methods as illustrated in FIGS. 1 through 6 may be implemented in the HMD to implement split-cadence eye tracking in the device.

FIG. 8 is a block diagram illustrating an example device that may include components and implement methods as illustrated in FIGS. 1 through 6, according to some embodiments.

In some embodiments, an XR system may include a device 2000 such as a headset, helmet, goggles, or glasses. Device 2000 may implement any of various types of display technologies. For example, device 2000 may include a transparent or translucent display 2060 (e.g., eyeglass lenses) through which the user may view the real environment and a medium integrated with display 2060 through which light representative of virtual images is directed to the wearer's eyes to provide an augmented view of reality to the wearer.

In some embodiments, device 2000 may include a controller 2060 configured to implement functionality of the XR system and to generate frames (each frame including a left and right image) that are provided to display 2030. In some embodiments, device 2000 may also include memory 2070 configured to store software (code 2074) of the XR system that is executable by the controller 2060, as well as data 2078 that may be used by the XR system when executing on the controller 2060. In some embodiments, memory 2070 may also be used to store video captured by camera 2050. In some embodiments, device 2000 may also include one or more interfaces (e.g., a Bluetooth technology interface, USB interface, etc.) configured to communicate with an external device (not shown) via a wired or wireless connection. In some embodiments, at least a part of the functionality described for the controller 2060 may be implemented by the external device. The external device may be or may include any type of computing system or computing device, such as a desktop computer, notebook or laptop computer, pad or tablet device, smartphone, hand-held computing device, game controller, game system, and so on.

In various embodiments, controller 2060 may be a uniprocessor system including one processor, or a multiprocessor system including several processors (e.g., two, four, eight, or another suitable number). Controller 2060 may include central processing units (CPUs) configured to implement any suitable instruction set architecture, and may be configured to execute instructions defined in that instruction set architecture. For example, in various embodiments controller 2060 may include general-purpose or embedded processors implementing any of a variety of instruction set architectures (ISAs), such as the x86, PowerPC, SPARC, RISC, or MIPS ISAs, or any other suitable ISA. In multiprocessor systems, each of the processors may commonly, but not necessarily, implement the same ISA. Controller 2060 may employ any microarchitecture, including scalar, superscalar, pipelined, superpipelined, out of order, in order, speculative, non-speculative, etc., or combinations thereof. Controller 2060 may include circuitry to implement microcoding techniques. Controller 2060 may include one or more processing cores each configured to execute instructions. Controller 2060 may include one or more levels of caches, which may employ any size and any configuration (set associative, direct mapped, etc.). In some embodiments, controller 2060 may include at least one graphics processing unit (GPU), which may include any suitable graphics processing circuitry. Generally, a GPU may be configured to render objects to be displayed into a frame buffer (e.g., one that includes pixel data for an entire frame). A GPU may include one or more graphics processors that may execute graphics software to perform a part or all of the graphics operation, or hardware acceleration of certain graphics operations. In some embodiments, controller 2060 may include one or more other components for processing and rendering video and/or images, for example image signal processors (ISPs), coder/decoders (codecs), etc.

Memory 2070 may include any type of memory, such as dynamic random access memory (DRAM), synchronous DRAM (SDRAM), double data rate (DDR, DDR2, DDR3, etc.) SDRAM (including mobile versions of the SDRAMs such as mDDR3, etc., or low power versions of the SDRAMs such as LPDDR2, etc.), RAMBUS DRAM (RDRAM), static RAM (SRAM), etc. In some embodiments, one or more memory devices may be coupled onto a circuit board to form memory modules such as single inline memory modules (SIMMs), dual inline memory modules (DIMMs), etc. Alternatively, the devices may be mounted with an integrated circuit implementing system in a chip-on-chip configuration, a package-on-package configuration, or a multi-chip module configuration. In some embodiments DRAM may be used as temporary storage of images or video for processing, but other storage options may be used to store processed data, such as Flash or other “hard drive” technologies.

In some embodiments, device 2000 may include one or more sensors 2010 that collect information about the user's environment (video, depth information, lighting information, head motion and pose information etc.). The sensors 2010 may provide the information to the controller 2060 of the XR system. In some embodiments, the sensors 2010 may include, but are not limited to, at least one visible light camera (e.g., an RGB video camera) 2050, ambient light sensors, an IMU (inertial measurement unit), and at least one eye tracking camera 2020. In some embodiments, device 2000 may also include one or more IR light sources; light from the light sources reflected off the eye may be captured by the eye tracking camera 2020. Gaze tracking algorithms implemented by controller 2060 may process images or video of the eye captured by the camera 2020 to determine eye pose and gaze direction. In addition, one or more of the methods as illustrated in FIGS. 1 through 6 may be implemented in device 2000 to implement split-cadence gaze or eye tracking in a device.

In some embodiments, device 2000 may be configured to render and display frames to provide an augmented or mixed reality (MR) view for the user based at least in part according to sensor inputs, including input from the eye tracking camera 2020. The MR view may include renderings of the user's environment, including renderings of real objects in the user's environment, based on video captured by one or more video cameras that capture high-quality, high-resolution video of the user's environment for display. The MR view may also include virtual content (e.g., virtual objects, virtual tags for real objects, avatars of the user, etc.) generated by the XR system and composited with the displayed view of the user's real environment.

### Extended Reality

A real environment refers to an environment that a person can perceive (e.g., see, hear, feel) without use of a device. For example, an office environment may include furniture such as desks, chairs, and filing cabinets; structural items such as doors, windows, and walls; and objects such as electronic devices, books, and writing instruments. A person in a real environment can perceive the various aspects of the environment, and may be able to interact with objects in the environment.

An extended reality (XR) environment, on the other hand, is partially or entirely simulated using an electronic device. In an XR environment, for example, a user may see or hear computer generated content that partially or wholly replaces the user's perception of the real environment. Additionally, a user can interact with an XR environment. For example, the user's movements can be tracked and virtual objects in the XR environment can change in response to the user's movements. As a further example, a device presenting an XR environment to a user may determine that a user is moving their hand toward the virtual position of a virtual object, and may move the virtual object in response. Additionally, a user's head position and/or eye gaze can be tracked and virtual objects can move to stay in the user's line of sight.

Examples of XR include augmented reality (AR), virtual reality (VR) and mixed reality (MR). XR can be considered along a spectrum of realities, where VR, on one end, completely immerses the user, replacing the real environment with virtual content, and on the other end, the user experiences the real environment unaided by a device. In between are AR and MR, which mix virtual content with the real environment.

VR generally refers to a type of XR that completely immerses a user and replaces the user's real environment. For example, VR can be presented to a user using a head mounted device (HMD), which can include a near-eye display to present a virtual visual environment to the user and headphones to present a virtual audible environment. In a VR environment, the movement of the user can be tracked and cause the user's view of the environment to change. For example, a user wearing a HMD can walk in the real environment and the user will appear to be walking through the virtual environment they are experiencing. Additionally, the user may be represented by an avatar in the virtual environment, and the user's movements can be tracked by the HMD using various sensors to animate the user's avatar.

AR and MR refer to a type of XR that includes some mixture of the real environment and virtual content. For example, a user may hold a tablet that includes a camera that captures images of the user's real environment. The tablet may have a display that displays the images of the real environment mixed with images of virtual objects. AR or MR can also be presented to a user through an HMD. An HMD can have an opaque display, or can use a see-through display, which allows the user to see the real environment through the display, while displaying virtual content overlaid on the real environment.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A device, comprising:
a camera configured to capture images of an eye; and
a controller comprising one or more processors configured to:
process reference frames based on images captured by the camera in a low-cadence pipeline to generate estimates of both position of the eye with respect to the device and rotation of the eye; and
process fast frames based on images captured by the camera in a high-cadence pipeline between the processing of the reference frames to generate estimates of only the rotation of the eye.

2. The device as recited in claim 1, wherein the position of the eye with respect to the device is estimated in three degrees of freedom as (X, Y, Z) coordinates in an image space.

3. The device as recited in claim 2, wherein a center of the eye is fixed in the image space.

4. The device as recited in claim 1, wherein the rotation of the eye is estimated in two degrees of freedom as azimuth and elevation.

5. The device as recited in claim 1, wherein the low-cadence pipeline processes a reference frame in response to a trigger event.

6. The device as recited in claim 5, wherein the trigger event is a timed event or a detected event.

7. The device as recited in claim 5, wherein the trigger event is detection of motion of the device or camera with respect to the eye.

8. The device as recited in claim 1, wherein the controller is further configured to:
estimate a gaze vector for the eye based at least in part on the position and rotation of the eye estimated for a reference frame in the low-cadence pipeline; and
perform interpolation to generate interpolated gaze vectors based on the rotation of the eye estimated for the fast frames in the high-cadence pipeline.

9. The device as recited in claim 1,
wherein the position of the eye is estimated from features of the eye detected in images that are captured using diffuse lighting, wherein the features include pupil and iris features; and
wherein the rotation of the eye is estimated from glints of the eye detected in images that are captured using specular lighting, wherein specular lighting used less power than diffuse lighting.

10. The device as recited in claim 1, wherein the rotation of the eye is estimated from glints of the eye detected in images, and wherein the controller is further configured to read out only a subset of rows or columns of pixels in an image that includes a region containing the glints to detect the glints.

11. The device as recited in claim 1, wherein the device is a head-mounted device (HMD) of an extended reality (XR) system.

12. A method, comprising:
performing, by a controller comprising one or more processors:
processing reference frames based on images captured by the camera in a low-cadence pipeline to generate estimates of both the position of the eye with respect to the device and rotation of the eye; and
processing fast frames based on images captured by the camera in a high-cadence pipeline between the processing of the reference frames to generate estimates of only the rotation of the eye.

13. The method as recited in claim 12, wherein the position of the eye with respect to the device is estimated in three degrees of freedom as (X, Y, Z) coordinates in an image space, and wherein the rotation of the eye is estimated in two degrees of freedom as azimuth and elevation.

14. The method as recited in claim 13, wherein a center of the eye is fixed in the image space.

15. The method as recited in claim 12, wherein a reference frame is processed in response to a trigger event, wherein the trigger event is a timed event or a detected event.

16. The method as recited in claim 15, wherein a reference frame is processed in response to detecting motion of the device or camera with respect to the eye.

17. The method as recited in claim 12, further comprising:
estimating a gaze vector for the eye based at least in part on the position and rotation of the eye estimated for a reference frame in the low-cadence pipeline; and
performing interpolation to generate interpolated gaze vectors based on the rotation of the eye estimated for the fast frames in the high-cadence pipeline.

18. The method as recited in claim 12, further comprising:
estimating the position of the eye from features of the eye detected in images that are captured using diffuse lighting, wherein the features include pupil and iris features; and
estimating rotation of the eye from glints of the eye detected in images that are captured using specular lighting, wherein specular lighting used less power than diffuse lighting.

19. The method as recited in claim 12, further comprising estimating rotation of the eye from glints of the eye detected in an image, wherein only a subset of rows or columns of pixels in the image that includes a region containing the glints are read out and processed to detect the glints.

20. A system, comprising:
a head-mounted device (HMD), comprising:
one or more light sources configured to illuminate an eye;
a camera configured to capture images of the eye; and
a controller comprising one or more processors configured to:
extract features from an image of the eye captured using diffuse lighting from the light sources, wherein the features include pupil and iris features;
estimate position of the eye with respect to the camera and rotation of the eye from the extracted features;
estimate a gaze vector for the eye based on the estimated position and rotation of the eye;
extract glints from two or more images of the eye captured using specular lighting from the light sources;
estimate rotation of the eye from the extracted glints; and
perform interpolation to generate interpolated gaze vectors based on the rotation of the eye estimated from the extracted glints.
